(19) United States
(12) Patent Application Publication
(10) Pub. No.: US 2026/0170235 A1
(43) Pub. Date: Jun. 18, 2026

(54) MACHINE LEARNING (ML) - ASSISTED GENERATION AND DISPLAY OF SUPPLEMENTAL INFORMATION MATERIAL FOR A PRESENTATION

(71) Applicants: Constructor Technology AG, Schaffhausen (CH); Constructor Education and Research Genossenschaft, Schaffhausen (CH)

(72) Inventors: Svetlana DERGACHEVA, Sofia (BG); Andrey ADASHCHIK, Istanbul (TR); Nikita ZHEREBTSOV, Sofia (BG); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/985,605

(22) Filed: Dec. 18, 2024

(51) Int. Cl. G06F 40/134; G06F 3/04842; G06F 16/22; G06F 16/26; G06F 40/177

(52) U.S. Cl. CPC G06F 40/134; G06F 3/04842; G06F 16/2282; G06F 16/26; G06F 40/177

(57) ABSTRACT

Disclosed herein are systems and method for using machine learning to generate/provide supplemental information material for a presentation. In an aspect, presentation material associated with the presentation is analyzed using a knowledge model to identify one or more elements in the presentation material, the one or more elements being associated with one or more concepts related to the presentation and/or related to a specific knowledge area of the knowledge model. For each element of the one or more elements, supplemental information material related to a concept associated with that element is created. A table that links each element of the one or more elements with corresponding supplemental information material is generated. The table links each element in the one or more elements with a position of that element in the presentation material.

### FIELD

The present disclosure relates to the field of machine learning, and, more specifically, to systems and methods for using machine learning to provide a presentation.

### BACKGROUND

Presentation and meeting hosting platforms, such as Zoom and MS Teams, typically allow multiple users to participate in virtual video/audio meetings, share their screens, display presentations and other content on their devices, such as smartphone, laptop computer, desktop computer. However, existing presentation hosting platforms have limited functionality in that they lack technical capability to supplement the information presented during a presentation to participants of the presentation. For example, while a presentation is in progress, a participant may need additional information on a topic/concept associated with the presentation. The participant may, for example, try to perform an online search to obtain additional information. However, this search may be tedious, time-consuming, unorganized, and distracting, and may also fail to result in complete relevant information that the participant is needing. For example, the participant may not know which places to look for the additional information, and/or may not have sufficient time to look into various possible sources of additional information, and/or may not be able to organize the searched information into a useful and concise collection of information.

### SUMMARY

Aspects of the present disclosure describe machine learning (ML)-assisted generation of supplemental material for a presentation, which addresses the shortcomings of conventional systems described above. In one exemplary aspect, a system receives presentation material related to a presentation and uses a knowledge model to identify important elements/concepts in the presentation material. For example, if the presentation is an online scientific lecture in which one or more slides are presented on user devices of participants of the scientific lecture, the system uses the knowledge model to identify one or more scientific terms in the contents of the slides. For each element/concept identified in the presentation material, the system uses a machine learning model to identify supplemental information material associated with that element. In the scientific lecture example, the supplemental information material associated with a scientific term may include, for example, a definition of the scientific term, a URL of a website that provides further information on the scientific concept, etc. The system then generates and saves a table (e.g., an organized collection of stored data/information) which links each element with the associated supplemental information material and with a location of that element in the presentation material. In the scientific lecture example, the location of a scientific term identifies which spot in which slide does the scientific term appear. The system saves the table so it can be used to provide the supplemental information material when the presentation is held. In the scientific lecture example, during the lecture, supplemental information material associated with a scientific term can be accessed at the location of the scientific term in a slide.

By efficiently providing curated supplemental information material during a presentation, the system according to the present aspects greatly enhances the personal experience for the participants of a presentation. Specifically, for example, the participants do not need to perform tedious, time-consuming, unorganized, and distracting searches to obtain their needed supplemental information during the presentation. Further, since each participant does not need to individually perform a search to obtain supplemental information, the system according to the present aspects allows for significant reduction in bandwidth, CPU, and other resource requirements on the entirety of the system as well as on each participant's device. Accordingly, the participants may use a simpler/less resource intensive device to attend the presentation while still being able to obtain any necessary supplemental information. Additionally, the trained machine learning models according to the present aspects provide relevant and comprehensive supplemental information that a participant may not be able to obtain on their own. Additionally, the machine learning models according to the present aspects can also be trained to adapt the supplemental information material according to the level of knowledge of a specific participant, thus further enhancing the quality, relevance, and usefulness of the supplemental information provided to a specific participant according to the participant's level of knowledge.

An example aspect of the present disclosure includes a method of using machine learning to provide supplemental information material for a presentation, the method comprising: receiving presentation material associated with the presentation; analyzing the presentation material using a knowledge model to identify one or more elements in the presentation material, the one or more elements being associated with one or more concepts related to the presentation and/or related to a specific knowledge area of the knowledge model; creating, for each element of the one or more elements, supplemental information material related to a concept associated with that element; and generating a table that links each element of the one or more elements with corresponding supplemental information material, the table further linking each element in the one or more elements with a position of that element in the presentation material.

In some implementations, the knowledge model comprises a machine learning model (MLM) as well as preloaded documents in the specific knowledge area.

In some implementations, the method further comprises repeating the analyzing, the creating, and the generating, responsive to a change or update in the preloaded documents.

In some implementations, analyzing the presentation material comprises performing retrieval-augmented generation (RAG) using the MLM and the preloaded documents in the specific knowledge area.

In some implementations, the method further comprises: storing the one or more elements in a database of elements; and storing the supplemental information material in a database of supplemental information.

In some implementations, the position of an element in the presentation material is defined by one or more spatial location identifiers of the element as presented in a visualization of the presentation material on a user device during the presentation.

In some implementations, the method further comprises holding the presentation including using the presentation material and the table to provide the presentation in conjunction with the supplemental information material on a user interface (UI) of the user device.

In some implementations, holding the presentation further comprises providing the element as a selectable element that is selectable, via the UI of the user device, at the position of the element as presented in the visualization of the presentation material during the presentation.

In some implementations, holding the presentation further comprises providing the supplemental information material responsive to a selection of the element via the UI of the user device during the presentation.

Another example aspect includes a system for using machine learning to provide supplemental information material for a presentation, the system comprising: at least one memory; and at least one hardware processor coupled with the at least one memory and configured, individually or in combination, to: receive presentation material associated with the presentation; analyze the presentation material using a knowledge model to identify one or more elements in the presentation material, the one or more elements being associated with one or more concepts related to the presentation and/or related to a specific knowledge area of the knowledge model; create, for each element of the one or more elements, supplemental information material related to a concept associated with that element; and generate a table that links each element of the one or more elements with corresponding supplemental information material, the table further linking each element in the one or more elements with a position of that element in the presentation material.

In some implementations, the knowledge model comprises a machine learning model (MLM) as well as preloaded documents in the specific knowledge area.

In some implementations, the at least one hardware processor are further configured, individually or in combination, to repeat the analyzing, the creating, and the generating, responsive to a change or update in the preloaded documents.

In some implementations, the at least one hardware processor are further configured, individually or in combination, to analyze the presentation material by performing retrieval-augmented generation (RAG) using the MLM and the preloaded documents in the specific knowledge area.

In some implementations, the at least one hardware processor are further configured, individually or in combination, to: store the one or more elements in a database of elements; and store the supplemental information material in a database of supplemental information.

In some implementations, the system comprises a cloud system.

In some implementations, one or more machine learning models configured for identifying the one or more elements or the corresponding supplemental information material are implemented using a graphics processing unit (GPU).

In some implementations, the position of an element in the presentation material is defined by one or more spatial location identifiers of the element as presented in a visualization of the presentation material on a user device during the presentation.

In some implementations, the at least one hardware processor are further configured, individually or in combination, to hold the presentation including using the presentation material and the table to provide the presentation in conjunction with the supplemental information material on a user interface (UI) of the user device.

In some implementations, the at least one hardware processor are further configured, individually or in combination, to hold the presentation by: providing the element as a selectable element that is selectable, via the UI of the user device, at the position of the element as presented in the visualization of the presentation material during the presentation; and providing the supplemental information material responsive to a selection of the element via the UI of the user device during the presentation.

Some further aspects include a non-transitory computer readable medium storing thereon computer executable instructions for using machine learning to provide supplemental information material for a presentation, including instructions for: receiving presentation material associated with the presentation; analyzing the presentation material using a knowledge model to identify one or more elements in the presentation material, the one or more elements being associated with one or more concepts related to the presentation and/or related to a specific knowledge area of the knowledge model; creating, for each element of the one or more elements, supplemental information material related to a concept associated with that element; and generating a table that links each element of the one or more elements with corresponding supplemental information material, the table further linking each element in the one or more elements with a position of that element in the presentation material.

Some further example aspects include a method of using machine learning to provide supplemental information material for a presentation, the method comprising: receiving presentation material associated with the presentation; obtaining, from a database, a table that links each element of one or more elements in the presentation with corresponding supplemental information material, the table further linking each element of the one or more elements with a position of that element in the presentation material, wherein the one or more elements are associated with one or more concepts related to the presentation and/or related to a specific knowledge area of a knowledge model used to generate the table; and holding the presentation including using the presentation material and the table to provide a visualization of the presentation in conjunction with the corresponding supplemental information material on a user interface (UI) of a user device.

In some implementations, holding the presentation further comprises providing each element in the one or more elements as a selectable element that is selectable, via the UI of the user device, at the position of that element as presented in the visualization of the presentation material during the presentation.

In some implementations, holding the presentation further comprises providing supplemental information material responsive to a selection of an element in the one or more elements via the UI of the user device during the presentation.

In some implementations, the method further comprises providing, on the UI of the user device, a feedback form configured to receive feedback on the supplemental information material associated with the element.

In some implementations, the method further comprises: receiving, via the UI of the user device, further supplemental information material associated with the element; and updating the table to include the further supplemental information material in association with the element.

In some implementations, the position of each element in the presentation material is defined by one or more spatial location identifiers of that element as presented in the visualization of the presentation material on the user device during the presentation.

In some implementations, the method further comprises: receiving a selection of a new element via the UI of the user device during the presentation; using the knowledge model to create new supplemental information material related to a concept associated with the new element; and adding the new element to the table, including linking, in the table, the new element with the new supplemental information material and a position of the new element in the presentation material.

In some implementations, the knowledge model comprises a machine learning model (MLM) as well as preloaded documents in the specific knowledge area.

In some implementations, the MLM is configured to adapt the supplemental information material in correspondence with a personal level of knowledge of a presentation participant associated with the user device.

In some implementations, using the knowledge model to create the new supplemental information material comprises performing retrieval-augmented generation (RAG) using the MLM and the preloaded documents in the specific knowledge area.

In some implementations, the method further comprises storing the new element in a database of elements.

In some implementations, the method further comprises storing the new supplemental information material in a database of supplemental information.

Some further aspects include a system for using machine learning to provide supplemental information material for a presentation, the system comprising: at least one memory; and at least one hardware processor coupled with the at least one memory and configured, individually or in combination, to: receive presentation material associated with the presentation; obtain, from a database, a table that links each element of one or more elements in the presentation with corresponding supplemental information material, the table further linking each element of the one or more elements with a position of that element in the presentation material, wherein the one or more elements are associated with one or more concepts related to the presentation and/or related to a specific knowledge area of a knowledge model used to generate the table; and hold the presentation including using the presentation material and the table to provide a visualization of the presentation in conjunction with the corresponding supplemental information material on a user interface (UI) of a user device.

In some implementations, the at least one hardware processor are further configured, individually or in combination, to hold the presentation by: providing each element in the one or more elements as a selectable element that is selectable, via the UI of the user device, at the position of that element as presented in the visualization of the presentation material during the presentation; and providing supplemental information material responsive to a selection of an element in the one or more elements via the UI of the user device during the presentation.

In some implementations, the at least one hardware processor are further configured, individually or in combination, to: provide, on the UI of the user device, a feedback form configured to receive feedback on the supplemental information material associated with the element; receive, via the UI of the user device, further supplemental information material associated with the element; and update the table to include the further supplemental information material in association with the element.

In some implementations, the position of each element in the presentation material is defined by one or more spatial location identifiers of that element as presented in the visualization of the presentation material on the user device during the presentation.

In some implementations, the at least one hardware processor are further configured, individually or in combination, to: receive a selection of a new element via the UI of the user device during the presentation; use the knowledge model to create new supplemental information material related to a concept associated with the new element; add the new element to the table, including linking, in the table, the new element with the new supplemental information material and a position of the new element in the presentation material; store the new element in a database of elements; and store the new supplemental information material in a database of supplemental information.

In some implementations, the knowledge model comprises a machine learning model (MLM) as well as preloaded documents in the specific knowledge area, wherein the at least one hardware processor are further configured, individually or in combination, to use the knowledge model to create the new supplemental information material by performing retrieval-augmented generation (RAG) using the MLM and the preloaded documents in the specific knowledge area.

In some implementations, the MLM is configured to adapt the supplemental information material in correspondence with a personal level of knowledge of a presentation participant associated with the user device.

Some further aspects include a non-transitory computer readable medium storing thereon computer executable instructions for using machine learning to provide supplemental information material for a presentation, including instructions for: receiving presentation material associated with the presentation; obtaining, from a database, a table that links each element of one or more elements in the presentation with corresponding supplemental information material, the table further linking each element of the one or more elements with a position of that element in the presentation material, wherein the one or more elements are associated with one or more concepts related to the presentation and/or related to a specific knowledge area of a knowledge model used to generate the table; and holding the presentation including using the presentation material and the table to provide a visualization of the presentation in conjunction with the corresponding supplemental information material on a user interface (UI) of a user device.

It should be noted that the methods described above may be implemented in a system comprising at least one hardware processor and memory. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations. Like reference numbers and designations in the various drawings indicate like elements.

FIG. 1 is a block diagram illustrating a system for using a machine learning (ML)-based presentation hosting platform to generate and display supplemental information material for a presentation, according to aspects of the present disclosure.

FIG. 2 is a flow diagram of a first method for using an ML-based presentation hosting platform to generate supplemental information material for a presentation, according to aspects of the present disclosure.

FIG. 3 is a flow diagram of a first method for providing supplemental information material during a presentation, according to aspects of the present disclosure.

FIG. 4 is a flow diagram of a second method for using an ML-based presentation hosting platform to generate supplemental information material for a presentation, according to aspects of the present disclosure.

FIG. 5 is a flow diagram of a second method for providing supplemental information material during a presentation, according to aspects of the present disclosure.

FIG. 6 is a block diagram illustrating a system for preparing one or more models for identifying elements/concepts in presentation material and identifying supplemental information material for an element, according to aspects of the present disclosure.

FIG. 7 is an example of a general-purpose computer system on which aspects of the present disclosure can be implemented.

### DETAILED DESCRIPTION

Exemplary aspects are described herein in the context of a system, method, and computer program product for using a machine learning (ML)-assisted presentation hosting platform to generate and display supplemental information material during a presentation. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Turning now to the figures, example aspects are depicted with reference to one or more components described herein, where components in dashed lines may be optional.

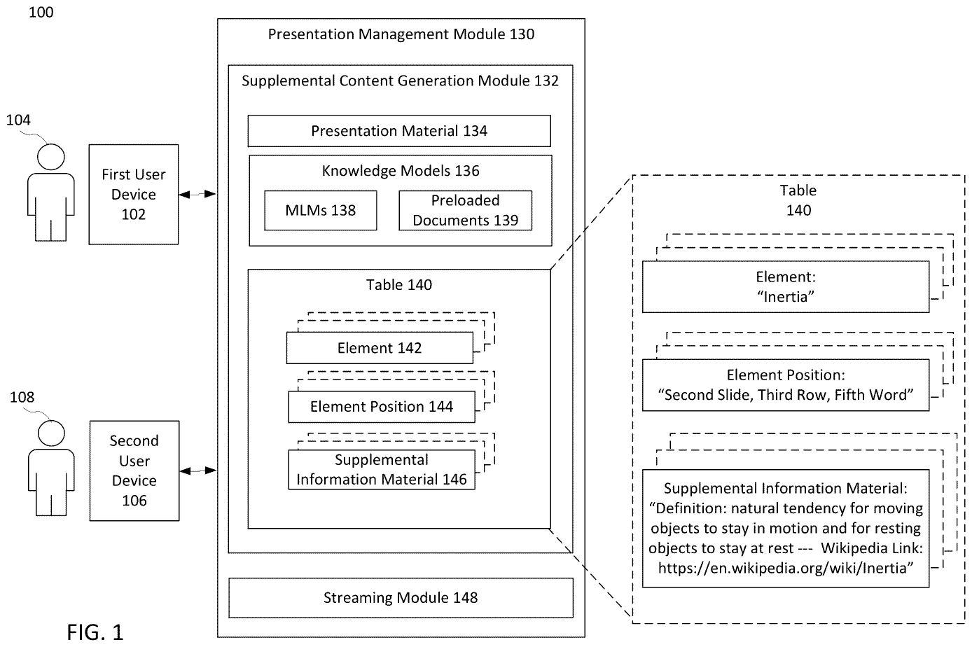

FIG. 1 is a block diagram illustrating a system 100 that provides an ML-assisted presentation hosting platform, according to aspects of the present disclosure. In the system 100, a first participant 104 who is using a first user device 102, and a second participant 108 who is using a second user device 106 participate in a presentation that is managed by a presentation management module 130. The presentation management module 130 is configured to hold the presentation using the first user device 102 and the second user device 106. Although only one user device is illustrated for each participant in FIG. 1, the present aspects are not so limited, and any number/type of user devices may be available to the participants of the presentation and may be used alone or in combination to hold to presentation. For example, each one of the first participant 104 and the second participant 108 may have access to one or more devices such as laptops and PCs (with different operating systems (Oss), e.g., Windows, macOS, Linux, etc.), smartphones (e.g., Android, iOS, etc.), tablets (e.g., Android, iOS, etc.), virtual and augmented reality devices (VR/AR), etc. The system 100 may then use one or any combination of these devices to hold the presentation.

The presentation management module 130 is configured to identify supplemental information material 146 to be presented in conjunction with the presentation. The supplemental information material 146 provides supplemental information associated with one or more contents/concepts of the presentation. For example, as discussed above with reference to a scientific lecture, the supplemental information material 146 may be associated with a scientific term in the presentation, such as a definition of the scientific term, a URL of a website that provides further information on the scientific term, etc.

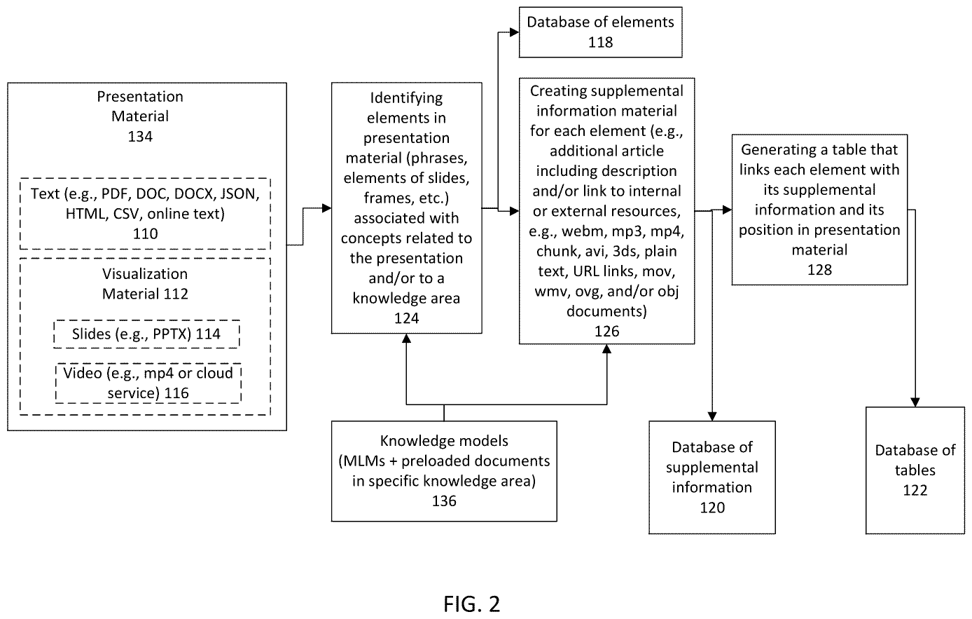

The presentation management module 130 identifies the supplemental information material 146 based on an analysis of presentation material 134 associated with the presentation. Referring now to both FIGS. 1 and 2, the presentation material 134 associated with the presentation may include one or more files that include text 110 (e.g., PDF, DOC, DOCX, JSON, HTML, CSV, online text), visualization material 112, etc. The visualization material 112 may include slides 114 (e.g., PPTX), video 116 (e.g., mp4 or cloud service), etc. In one non-limiting aspect, the first participant 104 may be a presenter of the presentation, and may upload the presentation material 134 to the system 100.

In order to identify supplemental information material 146, the presentation management module 130 executes a supplemental content generation module 132 that uses one or more knowledge models 136 to analyze the presentation material 134 and identify one or more elements 142 in the presentation material 134 (significant/important phrases and terms, related topics and concepts, graphical elements, elements of slides, image/video frames, etc.) associated with concepts related to the presentation and/or to a corresponding knowledge area (block 124 in FIG. 2). The presentation management module 130 then saves the elements 142 in a database of elements 118 (FIG. 2). The presentation management module 130 creates supplemental information material 146 for each element 142. This material may include additional articles, descriptions, and links to internal or external resources. It can also include multimedia objects such as images (JPEG, GIF, SVG, PNG), videos (WebM, MP4, AVI, MOV, WMV, OGV), audio files (MP3), 3D models (OBJ, 3DS), plain text, or URLs. See block 126 in FIG. 2 for example. Specifically, the presentation management module 130 uses one or more of the knowledge models 136 to identify the supplemental information material 146 for each identified element 142, as described in further detail below. The presentation management module 130 then saves the supplemental information material 146 in a database of supplemental information 120 (FIG. 2).

Each of the knowledge models 136 used for identifying the elements 142 and for identifying the supplemental information material 146 for each element 142 may include one or more ML models (MLMs) 138 (e.g., which may include a large language model (LLM) described below). Additionally, the knowledge models 136 may include preloaded documents 139 in a specific knowledge area related to a specific presentation (e.g., a specific scientific area related to a scientific lecture). Accordingly, the knowledge models 136 that include MLMs 138 and preloaded documents 139 may implement Retrieval-Augmented Generation (RAG), which is the process of optimizing the output of an MLM so it references an authoritative knowledge base outside of its training data sources before generating a response. When utilizing RAG methods, the information obtained from the document, as well as the context surrounding the elements 142, are presented in a way that is suitable for vector similarity search, e.g., transformed into vector space with the help of pretrained embedding model, where the text embedding model is a transformer-based text embedding model, for example, BERT (Bidirectional Encoder Representations from Transformers) or RoBERTa (Robustly optimized BERT approach).

An LLM is an advanced artificial intelligence system designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (which may include training, retraining, distillation, fine-tuning, etc.) to teach each LLM model to perform their respective specific tasks. As a non-limiting example, the LLM models may incorporate one of the machine learning models listed below.

A transformer is a deep learning architecture used in LLMs. A transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing and image classification and generation. Common examples of transformer models are generative pre-trained transformers (GPTs) and Bidirectional Encoder Representations from Transformers (BERTs).

A classification model is a type of machine learning model that is designed to predict the category or class to which a given data point belongs to. A classification model works by analyzing input features and assigning them to one of several predefined labels. These models are trained on labeled data, where the correct category is known, and they learn patterns that allow them to make predictions on new, unseen data. Examples of classification models include at least a regression model used for binary classification, a decision tree used to predict class by splitting data based on feature values, support vector machines (SVMs) configured to perform classification by finding the best boundary between classes, and neural networks.

In an aspect, the MLMs 138 may include one or more neural networks that are trained to automatically identify the elements 142 as well as one or more neural networks that are trained to automatically identify the supplemental information material 146 associated with each of the identified elements 142. Neural networks are a class of machine learning models inspired by the structure and functioning of the human brain. They consist of interconnected nodes, called neurons, or artificial neurons, organized into layers. Neural networks are capable of learning complex patterns and representations from data. The MLMs 138 used for identifying the elements 142 and for identifying the supplemental information material 146 for each element 142 may include one or more of the following neural networks: autoregressive large language models with multi-modal capabilities, encoder/decoder transformer neural networks, convolution neural networks (CNNs), recurrent neural networks (RNNs), long short-term memory (LSTM) networks, gated recurrent unit (GRU) networks, autoencoders, and generative adversarial networks (GANs).

A CNN is specialized for processing grid-like data, such as images, and employs convolutional layers to learn spatial hierarchies of features, reducing the need for manual feature engineering. CNNs are well-suited for tasks like image classification, object detection, and image generation. An RNN is designed for sequential data, where the order of inputs matters. An RNN includes loops in the network architecture to allow information to persist, and is useful for tasks like natural language processing, speech recognition, and time-series prediction. An LSTM network is an extension of an RNN designed to overcome the vanishing gradient problem. LSTMs have memory cells that can store and retrieve information over long sequences, making them effective for capturing long-term dependencies in sequential data. A GRU network is similar to LSTMs and is another type of RNN with mechanisms to address the vanishing gradient problem. GRUs have a simpler architecture with fewer parameters compared to LSTMs. An autoencoder is a type of neural network used for unsupervised learning and dimensionality reduction, and consists of an encoder that compresses input data into a lower-dimensional representation (encoding) and a decoder that reconstructs the original input from the encoding. A GAN comprises a generator and a discriminator trained simultaneously through adversarial training. The generator aims to generate realistic data, while the discriminator tries to distinguish between real and generated data. A GAN is widely used for image and content generation tasks.

For analysis tasks such as identifying the elements 142 in the presentation material 134, an untrained MLM will first analyze data from a training set to “learn” which elements are important/significant and which elements are unimportant/insignificant. As an example, the training dataset may include at least: a plurality of presentation documents, a plurality of significant/important elements in the presentation documents, and a plurality of insignificant/unimportant elements in the presentation documents. During preparing (which may include training, retraining, distillation, fine-tuning, etc.), the training dataset are input through the untrained MLM. The results from the untrained MLM are then compared with known dataset results using the corresponding labels identifying the type of elements (e.g., significant/important or insignificant/unimportant). It should be noted that the input to the trained MLM will be data from the training dataset.

For every input training sample from the training dataset, the trained MLM will produce a prediction consisting of values representing a probability that a particular significant/important element is correctly identified. The trained MLM then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the MLM is trained, the trained MLM may be used for inference, e.g., for identifying the significant/important elements. During inference, the trained MLM does not re-evaluate or adjust the layers of the neural network based on the results. Instead, the inference applies knowledge from the trained neural network and uses it to infer a result (e.g., identify a significant/important element). Accordingly, when a new unknown dataset (e.g., new presentation material) is input through the trained neural network, the trained MLM outputs a prediction of an accuracy of element identification based on predictive accuracy of the MLM.

Similarly, for analysis tasks such as identifying the supplemental information material 146 associated with each of the identified elements 142, an untrained MLM will first analyze data from a training set to “learn” which supplemental information is associated with an element and which supplemental information is unrelated to an element. As an example, the training dataset may include at least: a plurality of supplemental information material (links, documents, etc.) related to an element, and a plurality of supplemental information material that are unrelated to an element. During preparing (which may include training, retraining, distillation, fine-tuning, etc.), the training dataset are input through the untrained MLM. The results from the untrained MLM are then compared with known dataset results using the corresponding labels identifying the type of supplemental information (e.g., related or unrelated to the element). It should be noted that the input to the trained MLM will be data from the training dataset.

For every input training sample from the training dataset, the trained MLM will produce a prediction consisting of values representing a probability that a particular supplemental information is correctly identified. The trained MLM then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the MLM is trained, the trained MLM may be used for inference, e.g., for identifying the supplemental information material. During inference, the trained MLM does not re-evaluate or adjust the layers of the neural network based on the results. Instead, the inference applies knowledge from the trained neural network and uses it to infer a result (e.g., identify related supplemental information). Accordingly, when a new unknown dataset (e.g., new element) is input through the trained neural network, the trained MLM outputs a prediction of an accuracy of identification of related supplemental information based on predictive accuracy of the MLM.

It should be noted that the identification of the elements 142 and the identification of the supplemental information material 146 for each identified element 142 as described in the present disclosure are heavily simplified. One skilled in the art will appreciate that the MLMs utilized may have significantly large datasets with highly specific details. For example, the presentation material 134 may include sentences, and the MLM may be trained to identify various components that form a sentence and then process only keywords in each sentence to determine if a keyword is a significant/important element. As another example, the presentation material 134 may include a large amount of data including textbooks that need to be analyzed by the MLMs to identify significant/important elements. This type of analysis would be beyond the capabilities of the human mind because the amount of data to be identified, considered, and processed when is unfathomable.

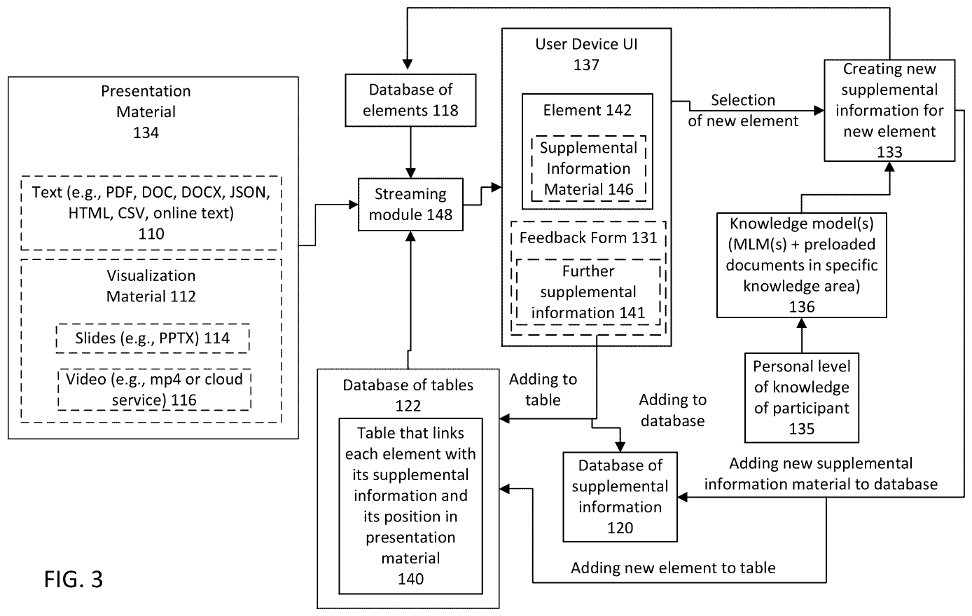

After identifying the elements 142 and their corresponding supplemental information material 146, the system generates and saves a table 140 which links each element 142 with the associated supplemental information material 146 and with a position 144 of that element 142 in the presentation material 134 (block 128 in FIG. 2). The table 140 is a data structure including an organized collection of stored data/information. In the scientific lecture example, the position of a scientific term identifies which spot in which slide does the scientific term appear. For example, the table may store and link the scientific term “inertia” with the position of the scientific term in the presentation material “Second Slide, Third Row, Fifth Word,” and with corresponding supplemental information material “Definition: natural tendency for moving objects to stay in motion and for resting objects to stay at rest—Wikipedia Link: https://en.wikipedia.org/wiki/Inertia.” The system 100 saves the table 140 so it can be used to provide the supplemental information material 146 when the presentation is held (see FIG. 3 described below). In the scientific lecture example, during the lecture, supplemental information material associated with a scientific term can be accessed at the location of the scientific term in a slide (see FIG. 3 described below).

In one non-limiting example aspect, the table 140 may be a stored data structure in which an element, its position, and its supplemental information material are logically linked and organized such that they can be accessed together. For example, the table 140 may store the actual values (e.g., text) of an element, its position, and its supplemental information material together. For example, the table 140 may store these values sequentially in a same cell, or in sequential cells, or in a same row or column of the table 140. In this case, the linking is achieved by virtue of the actual values being saved together (e.g., stored sequentially in a same cell of the table 140, stored in sequential cells of the table 140, or stored in a same row or column of the table 140, etc.).

Alternatively, the table 140 may store metadata such as address pointers that point to the stored location of an element, its position, and its supplemental information material, so that the address pointers can be followed to locate where the actual values (e.g., text) of the element, its position, and its supplemental information material are stored. In this case, the linking is achieved by virtue of the pointers being stored in the table 140 together (e.g., stored sequentially in a same cell of the table 140, stored in sequential cells of the table 140, stored in a same row or column of the table 140, etc.). One of ordinary skill may contemplate other ways of creating a table that links an element, its position, and its supplemental information material.

Thus, the system according to the present aspects provides interactive presentations that allow for all participants (and not just hosts) to interact with the presentation material during the presentation. For example, as a presentation is held, and as presentation material are displayed on a UI of a user device of a participant, the participant may interact with the presentation material by clicking with their mouse pointer on various dynamic elements of the presentation displayed on the UI of their user device, in order to access relevant supplemental information material. This is an important technical improvement over current “static” presentation hosting platforms, such as Zoom and Teams, which allow only the host of a presentation to control the presentation material. This interactive functionality significantly enhances user experience, for example, by improving consumption/comprehension of the presentation material by the participants, increasing user engagement with the presentation material, etc.

Further, in some aspects, the supplemental information material embedded into the presentation can be reviewed by the presentation creator or obtained from the creator-approved sources or MLMs trained on creator-approved knowledge models. This significantly improves accuracy of the supplemental information materials because all participants have immediate access to all relevant and updated supplemental information material in real-time and don't have to research this material on their own and inadvertently rely on incorrect or outdated sources.

Referring now to FIGS. 1 and 3, after the table 140 is generated and stored, the presentation management module 130 may execute a streaming module 148 to hold the presentation and also provide the supplemental information material 146 for each element 142 on a user device UI 137. For example, during the presentation, the streaming module 148 may render the presentation on the user device UI 137 of a participant's user device. As the presentation is being rendered, the streaming module 148 may identify the X/Y coordinates of a mouse click on the user device UI 137 and compare the X/Y coordinates against the rendering of the presentation on the user device UI 137 to determine which position in the presentation material 134 does the mouse click corresponds to. Once the position in the presentation material 134 is identified, the streaming module 148 may use the table 140 to identity the corresponding element and the corresponding supplemental information material associated with that position, as stored and linked in the table 140. The streaming module 148 may then display a UI component such a bubble on the user device UI 137 to indicate availability of the supplemental information material for the element in the clicked position. The user may then click on the bubble to view the supplemental information material.

In some optional implementation, a feedback form 131 may also be displayed on the user device UI 137 to obtain further supplemental information 141 from the user device UI 137, for example, in case a user/participant is aware of additional or different supplemental information that could be relevant to the element 142. The further supplemental information 141 received via the feedback form 131 is saved in the database of supplemental information 120 and is also added to the appropriate table 140 and saved in the database of tables 122.

In some implementations, a user may also identify a new (previously unidentified) element via the user device UI 137. For example, during a presentation, a user may identify a new/important element displayed during the presentation on the user device UI 137, where no supplemental information is being provided on the user device UI 137 for the new element. The user may then select the new element on the user device UI 137, causing the system 100 to save the new element in the database of elements 118 and use the knowledge model 136 to create new supplemental information for the new element (block 133 in FIG. 3). In some implementations, in identifying supplemental information for the new element (or for any other previously identified element), the knowledge model 136 may also take into account a personal level of knowledge of a participant (block 135 in FIG. 3). The new element and the new supplemental information are then added to the table 140 and are linked in the table 140 with each other and with a position of the new element in the presentation material. Accordingly, the table can be accessed so that the new element and its associated supplemental information can be presented during future presentations.

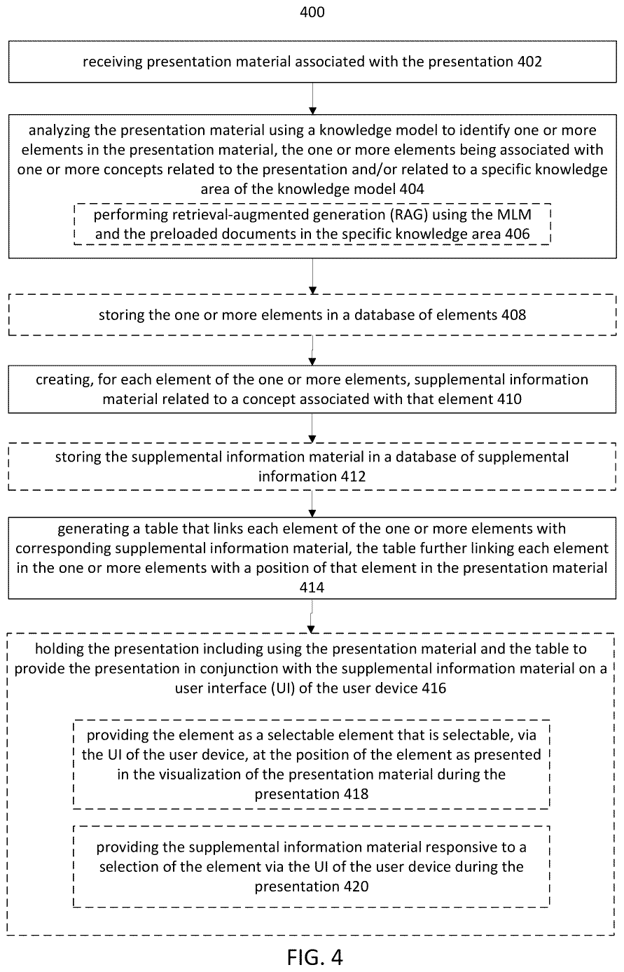

FIG. 4 is a flow diagram of a method 400 of using machine learning to provide supplemental information material for a presentation, according to aspects of the present disclosure. In various implementations, the method 400 is performed by a device with one or more processors and non-transitory memory. In some implementations, the method 400 is performed by processing logic, including hardware, firmware, software, or a combination thereof. In some implementations, the method 400 is performed by a processor executing code stored in a non-transitory computer-readable medium (e.g., a memory).

At block 402 the method 400 includes receiving presentation material associated with the presentation. For example, referring to FIG. 1, the supplemental content generation module 132 of the presentation management module 130 may receive the presentation material 134 associated with a presentation, which may include one or more files that include text 110 (e.g., PDF, DOC, DOCX, JSON, HTML, CSV, online text), visualization material 112, etc. The visualization material 112 may include slides 114 (e.g., PPTX), video 116 (e.g., mp4 or cloud service), etc. In one non-limiting aspect, for example, the first participant 104 may be a presenter of the presentation, and may upload the presentation material 134 to the system 100.

At block 404 the method 400 includes analyzing the presentation material using a knowledge model to identify one or more elements in the presentation material, the one or more elements being associated with one or more concepts related to the presentation and/or related to a specific knowledge area of the knowledge model. For example, in an aspect, the presentation management module 130 executes the supplemental content generation module 132 that uses one or more knowledge models 136 to analyze the presentation material 134 and identify one or more elements 142 in the presentation material 134 (significant/important phrases and terms, related topics and concepts, graphical elements, elements of slides, image/video frames, etc.) associated with concepts related to the presentation and/or to a corresponding knowledge area.

In some implementations, the knowledge model comprises a machine learning model (MLM) as well as preloaded documents in the specific knowledge area. For example, in an aspect, the knowledge models 136 may include one or more ML models (MLMs) 138 (e.g., which may include a large language model (LLM) described below). Additionally, the knowledge models 136 may include preloaded documents 139 in a specific knowledge area related to a specific presentation (e.g., a specific scientific area related to a scientific lecture).

In some implementations, analyzing the presentation material at block 404 may include optional block 406, and at optional block 406 the method 400 may further include performing retrieval-augmented generation (RAG) using the MLM and the preloaded documents in the specific knowledge area. For example, in an aspect, the knowledge models 136 that include MLMs 138 and preloaded documents 139 may implement Retrieval-Augmented Generation (RAG), which is the process of optimizing the output of an MLM so it references an authoritative knowledge base outside of its training data sources before generating a response. When utilizing RAG methods, the information obtained from the document, as well as the context surrounding the elements 142, are presented in a way that is suitable for vector similarity search, e.g., transformed into vector space with the help of pretrained text embedding model, where the text embedding model is a transformer-based text embedding model, for example, BERT or RoBERTa.

In some implementations, at optional block 408 the method 400 may further include storing the one or more elements in a database of elements. For example, in an aspect, the presentation management module 130 saves the identified elements 142 in a database of elements 118.

At block 410 the method 400 includes creating, for each element of the one or more elements, supplemental information material related to a concept associated with that element. For example, in an aspect, the presentation management module 130 creates supplemental information material 146 for each element 142. This material may include additional articles, descriptions, and links to internal or external resources. It can also include multimedia objects such as images (JPEG, GIF, SVG, PNG), videos (WebM, MP4, AVI, MOV, WMV, OGV), audio files (MP3), 3D models (OBJ, 3DS), plain text, or URLs.

In some implementations, at optional block 412 the method 400 may further include storing the supplemental information material in a database of supplemental information. For example, in an aspect, the presentation management module 130 saves the supplemental information material 146 in a database of supplemental information 120.

At block 414 the method 400 includes generating a table that links each element of the one or more elements with corresponding supplemental information material, the table further linking each element in the one or more elements with a position of that element in the presentation material. For example, in an aspect, after identifying the elements 142 and their corresponding supplemental information material 146, the supplemental content generation module 132 generates and saves a table 140 which links each element 142 with the associated supplemental information material 146 and with a position 144 of that element 142 in the presentation material 134.

In some implementations, the position of an element in the presentation material is defined by one or more spatial location identifiers of the element as presented in a visualization of the presentation material on a user device during the presentation. For example, in the scientific lecture example, the position of a scientific term identifies which spot in which slide does the scientific term appear. For example, the table may store and link the scientific term “inertia” with the position of the scientific term in the presentation material “Second Slide, Third Row, Fifth Word,” and with corresponding supplemental information material “Definition: natural tendency for moving objects to stay in motion and for resting objects to stay at rest—Wikipedia Link: https://en.wikipedia.org/wiki/Inertia.”

Some optional implementations may repeat the analyzing at block 404, the creating at block 410, and the generating at block 414, responsive to a change or update in the preloaded documents.

In some implementations, at optional block 416 the method 400 may further include holding the presentation including using the presentation material and the table to provide the presentation in conjunction with the supplemental information material on a user interface (UI) of the user device. For example, in an aspect, after the table 140 is generated and stored, the presentation management module 130 may execute a streaming module 148 to hold the presentation and also use the table 140 to provide the supplemental information material 146 for each element 142 on a user device UI 137.

In some implementations, holding the presentation at optional block 416 may further include optional block 418, and at optional block 418 the method 400 may further include providing the element as a selectable element that is selectable, via the UI of the user device, at the position of the element as presented in the visualization of the presentation material during the presentation. For example, in an aspect, during the presentation, the streaming module 148 may render the presentation on the user device UI 137 of a participant. As the presentation is being rendered, the streaming module 148 may identify the X/Y coordinates of a mouse click on the user device UI 137 and compare the X/Y coordinates against the rendering of the presentation on the user device UI 137 to determine which position in the presentation material 134 does the mouse click corresponds to. Once the position in the presentation material 134 is identified, the streaming module 148 may use the table 140 to identity the corresponding element and the corresponding supplemental information material associated with that position, as stored and linked in the table 140. The streaming module 148 may then display a UI component such a bubble on the user device UI 137 to indicate availability of the supplemental information material for the element in the clicked position.

In some implementations, holding the presentation at optional block 416 may further include optional block 420, and at optional block 420 the method 400 may further include providing the supplemental information material responsive to a selection of the element via the UI of the user device during the presentation. For example, if a user clicks on a bubble associated with an element, the streaming module 148 provides the supplemental information material for the element in the clicked position.

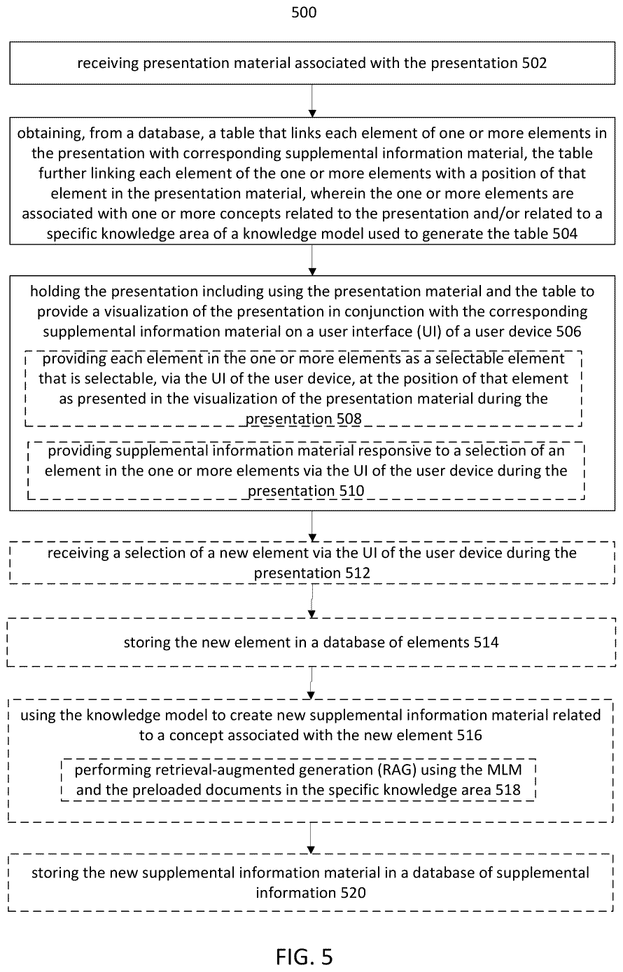

FIG. 5 is a flow diagram of a method 500 of using machine learning to provide supplemental information material for a presentation, according to aspects of the present disclosure. In various implementations, the method 500 is performed by a device with one or more processors and non-transitory memory. In some implementations, the method 400 is performed by processing logic, including hardware, firmware, software, or a combination thereof. In some implementations, the method 500 is performed by a processor executing code stored in a non-transitory computer-readable medium (e.g., a memory).

At block 502 the method 500 includes receiving presentation material associated with the presentation. For example, referring to FIG. 1, the streaming module 148 of the presentation management module 130 may receive the presentation material 134 associated with a presentation, which may include one or more files that include text 110 (e.g., PDF, DOC, DOCX, JSON, HTML, CSV, online text), visualization material 112, etc. The visualization material 112 may include slides 114 (e.g., PPTX), video 116 (e.g., mp4 or cloud service), etc. In one non-limiting aspect, the first participant 104 may be a presenter of the presentation, and may upload the presentation material 134 to the system 100.

At block 504 the method 500 includes obtaining, from a database, a table that links each element of one or more elements in the presentation with corresponding supplemental information material, the table further linking each element of the one or more elements with a position of that element in the presentation material, wherein the one or more elements are associated with one or more concepts related to the presentation and/or related to a specific knowledge area of a knowledge model used to generate the table. For example, in an aspect, the streaming module 148 obtains the table 140 from the database of tables 122. The table 140 links each element 142 with the associated supplemental information material 146 and with a position 144 of that element 142 in the presentation material 134, as described herein.

In some implementations, the knowledge model comprises a machine learning model (MLM) as well as preloaded documents in the specific knowledge area. For example, in an aspect, the knowledge models 136 may include one or more ML models (MLMs) 138 (e.g., which may include a large language model (LLM) described below). Additionally, the knowledge models 136 may include preloaded documents 139 in a specific knowledge area related to a specific presentation (e.g., a specific scientific area related to a scientific lecture).

In some implementations, the MLM is configured to adapt the supplemental information material in correspondence with a personal level of knowledge of a presentation participant associated with the user device. For example, referring to block 135 in FIG. 3, the knowledge model 136 may take into account a personal level of knowledge of a participant associated with a user device on which the presentation is being rendered.

In some implementations, the position of each element in the presentation material is defined by one or more spatial location identifiers of that element as presented in the visualization of the presentation material on the user device during the presentation. For example, in the scientific lecture example, the position of a scientific term identifies which spot in which slide does the scientific term appear. For example, the table may store and link the scientific term “inertia” with the position of the scientific term in the presentation material “Second Slide, Third Row, Fifth Word,” and with corresponding supplemental information material “Definition: natural tendency for moving objects to stay in motion and for resting objects to stay at rest—Wikipedia Link: https://en.wikipedia.org/wiki/Inertia.”

At block 506 the method 500 includes holding the presentation including using the presentation material and the table to provide a visualization of the presentation in conjunction with the corresponding supplemental information material on a user interface (UI) of a user device. For example, in an aspect, the streaming module 148 may hold the presentation and also use the table 140 to provide the supplemental information material 146 for each element 142 on a user device UI 137.

In some implementations, holding the presentation at block 506 may further include optional block 508, and at optional block 508 the method 500 may further include providing each element in the one or more elements as a selectable element that is selectable, via the UI of the user device, at the position of that element as presented in the visualization of the presentation material during the presentation. For example, in an aspect, during the presentation, the streaming module 148 may render the presentation on the user device UI 137 of a participant. As the presentation is being rendered, the streaming module 148 may identify the X/Y coordinates of a mouse click on the user device UI 137 and compare the X/Y coordinates against the rendering of the presentation on the user device UI 137 to determine which position in the presentation material 134 does the mouse click corresponds to. Once the position in the presentation material 134 is identified, the streaming module 148 may use the table 140 to identity the corresponding element and the corresponding supplemental information material associated with that position, as stored and linked in the table 140. The streaming module 148 may then display a UI component such a bubble on the user device UI 137 to indicate availability of the supplemental information material for the element in the clicked position.

In some implementations, holding the presentation at block 506 may further include optional block 510, and at optional block 510 the method 500 may further include providing supplemental information material responsive to a selection of an element in the one or more elements via the UI of the user device during the presentation. For example, if a user clicks on a bubble associated with an element, the streaming module 148 provides the supplemental information material for the element in the clicked position.

Some implementations may further provide, on the UI of the user device, a feedback form configured to receive feedback on the supplemental information material associated with the element, and may further receive, via the UI of the user device, further supplemental information material associated with the element, and update the table to include the further supplemental information material in association with the element. For example, in some optional implementation, a feedback form 131 may also be displayed on the user device UI 137 to obtain further supplemental information 141 from the user device UI 137, for example, in case a user/participant is aware of additional or different supplemental information that could be relevant to the element 142. The further supplemental information 141 received via the feedback form 131 is saved in the database of supplemental information 120 and is also added to the appropriate table 140 and saved in the database of tables 122.

In some implementations, at optional block 512 the method 500 may further include receiving a selection of a new element via the UI of the user device during the presentation. For example, in some implementations, a user may also identify a new (previously unidentified) element via the user device UI 137. For example, during a presentation, a user may identify a new/important element displayed during the presentation on the user device UI 137, where no supplemental information is being provided on the user device UI 137 for the new element.

In some implementations, at optional block 514 the method 500 may further include storing the new element in a database of elements. For example, when a user selects a new element on the user device UI 137, the system 100 saves the new element in the database of elements 118.

In some implementations, at optional block 516 the method 500 may further include using the knowledge model to create new supplemental information material related to a concept associated with the new element. For example, referring to block 133 in FIG. 3, the system 100 uses the knowledge model 136 to create new supplemental information for the new element.

Some implementations further add the new element to the table, including linking, in the table, the new element with the new supplemental information material and a position of the new element in the presentation material. For example, in some aspects, the new element and the new supplemental information are added to the table 140 and are linked in the table 140 with each other and with a position of the new element in the presentation material 134. Accordingly, the table can be accessed so that the new element and its associated supplemental information can be presented during future presentations.

In some implementations, using the knowledge model to create the new supplemental information material at optional block 516 may further include optional block 518, and at optional block 518 the method 500 may further include performing retrieval-augmented generation (RAG) using the MLM and the preloaded documents in the specific knowledge area. For example, referring to block 133 in FIG. 3, the system 100 uses the knowledge model 136 to create new supplemental information for the new element, where the knowledge model includes MLMs 138 and preloaded documents 139 and implements Retrieval-Augmented Generation (RAG), as described herein above.

In some implementations, at optional block 520 the method 500 may further include storing the new supplemental information material in a database of supplemental information. For example, the system 100 saves the new supplemental information material in the database of supplemental information 120.

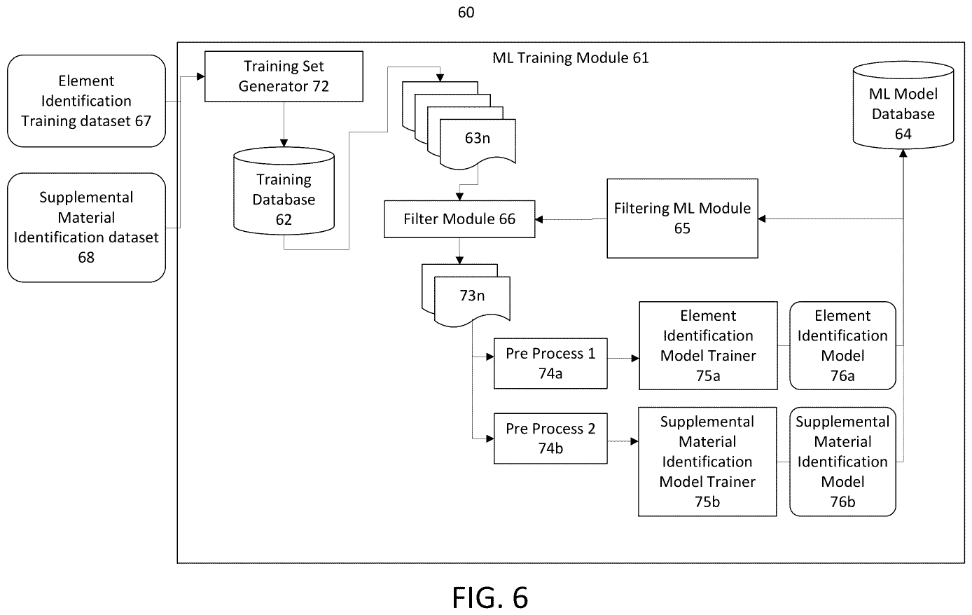

FIG. 6 is a block diagram illustrating an example of a system 60 for preparing (which may include training, retraining, distillation, fine-tuning, etc.) one or more machine learning models for identifying elements/concepts in presentation material and one or more machine learning models for identifying supplemental information material for an element, according to aspects of the present disclosure. As shown in system 60, an ML training module 61 is configured to build and prepare (which may include training, retraining, distillation, fine-tuning, etc.) specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained data sets, the specialized machine learning models may perform particular tasks such as identifying an element in presentation material or identifying supplemental information material for an element in a presentation as described herein.

Supervised learning is effective for tasks such as classification (assigning inputs to predefined categories) and regression (predicting continuous values) since it relies on the availability of labeled data for both training and evaluation phases. In supervised learning, the ML training module 61 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 61 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 61 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, the ML training module 61 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 61 includes at least a training database 62 configured to store the raw training data 63n and corresponding labels, a ML model database 64 configured to store the trained models (e.g., element identification model 76a and supplemental material information model 76b). In some aspects, the ML training module 61 may include a filtering machine learning module 65 and a filter module 66 configured to filter data from the training database 62 for training by removing poorly generated training data.

Training data from an element identification training dataset 67 and a supplemental information material identification dataset 68 is received into the ML training module 61 via the training set generator 72. In some aspects, the element identification training dataset 67 includes at least: a plurality of presentation documents, a plurality of significant/important elements in the presentation documents, and a plurality of insignificant/unimportant elements in the presentation documents. In some aspects, the supplemental information material identification dataset 68 includes at least: a plurality of supplemental information material (links, documents, etc.) related to an element, and a plurality of supplemental information material that are unrelated to an element.

An optional filter module 66 is configured to filter out bad training images and/or data in order to clean up the training data in the training dataset 63n. In some examples, the filter module 66 may be a neural network. In some examples, the filter module 66 is a mathematical model. In some examples, the cleaned training dataset 73n then undergoes optional preprocessing steps depending on which neural network or model is being trained.

The optional preprocess 1 74a and preprocess 2 74b are automated processes that modify the raw data received from 63n (or cleaned training dataset 73n) and prepare the raw data as input to the respective model trainers (e.g., an element identification model trainer 75a and a supplemental material identification model trainer 75b). These may be described in the machine learning training module 61 as snippets of code that prepares the datasets. In some examples, the preprocessing module (e.g., preprocess 1 74a and preprocess 2 74b) for a particular trainer may be an automated script or code that will be setup the first time any model is trained.

The element identification model trainer 75a and the supplemental material identification model trainer 75b are the scripts or code that train the model. The element identification model trainer 75a and the supplemental material identification model trainer 75b may be a script or code that holds the instructions on how a model should be trained (e.g., optimization method, model architecture, dataset division, etc.) and also runs the training. The element identification model trainer 75a and the supplemental material identification model trainer 75b each take as input the raw or filtered processed training data and train the element identification model 76a and the supplemental information identification model 76b, to achieve their specific objectives, respectively.

In summary, the raw dataset 63n or cleaned dataset 73n may optionally go through different preprocessing steps 74a and 74b and then a corresponding one of the element identification model trainer 75a and the supplemental material identification model trainer 75b to generate a trained element identification model 76a and a trained supplemental information model 76b. In some examples, each of these models may be a neural network.

As a non-limiting example, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 63n used for preparing a model (which may include training, retraining, distillation, fine-tuning, etc.) may include noise and bad training data from the training database 62. Accordingly, to create a clean and filtered training dataset, the filter module 66 is configured to filter out unwanted data points from the raw training dataset 63n by developing smaller, less accurate systems based on patterns and metadata information.

During the preparing process (which may include training, retraining, distillation, fine-tuning, etc.), the element identification model trainer 75a and the supplemental material identification model trainer 75b (e.g., neural networks) are presented with input data and labels of actual values, and the optimization objective, which aims to minimize the difference between the actual value and the predicted value, is calculated. The optimization algorithm updates the parameters of the element identification model trainer 75a and the supplemental material identification model trainer 75b to reduce the value of the objective. This process is repeated for several iterations until the parameters do not change anymore. This process is repeated for various combinations of hyperparameters, and the model with the smallest label prediction error is selected as the final model.

When a new model (e.g., a trained element identification model 76a and a trained supplemental information identification model 76b) is created, and a new process for filtering and automated labeling is established, it is added to the ML model database 64 in the ML training module 61. This enables the new model to be part of the closed-loop model update process. Optionally, at regular intervals, data which is continuously collected can be filtered, labeled, and used to update old models by an optional filtering machine learning module 65. In some examples, the filtering machine learning module 65 is a neural network. In some examples, the filtering machine learning module 65 is a mathematical model. This approach may capture changes in the data over time.

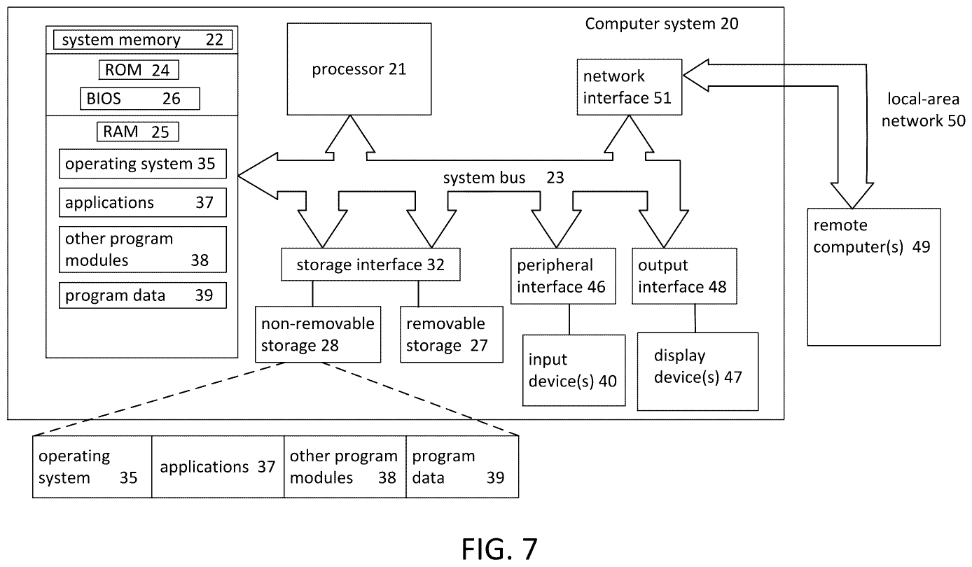

FIG. 7 is a block diagram illustrating a computer system 20 on which aspects of systems and methods for using machine learning to provide supplemental information material for a presentation may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the CPU 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any commands/steps/functions discussed herein with reference to FIGS. 2-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method of using machine learning to provide supplemental information material for a presentation, the method comprising:
receiving presentation material associated with the presentation;
obtaining, from a database, a table that links each element of one or more elements in the presentation with corresponding supplemental information material, the table further linking each element of the one or more elements with a position of that element in the presentation material, wherein the one or more elements are associated with one or more concepts related to the presentation and/or related to a specific knowledge area of a knowledge model used to generate the table; and
holding the presentation including using the presentation material and the table to provide a visualization of the presentation in conjunction with the corresponding supplemental information material on a user interface (UI) of a user device.

2. The method of claim 1, wherein holding the presentation further comprises providing each element in the one or more elements as a selectable element that is selectable, via the UI of the user device, at the position of that element as presented in the visualization of the presentation material during the presentation.

3. The method of claim 2, wherein holding the presentation further comprises providing supplemental information material responsive to a selection of an element in the one or more elements via the UI of the user device during the presentation.

4. The method of claim 3, further comprising providing, on the UI of the user device, a feedback form configured to receive feedback on the supplemental information material associated with the element.

5. The method of claim 4, further comprising:
receiving, via the UI of the user device, further supplemental information material associated with the element; and
updating the table to include the further supplemental information material in association with the element.

6. The method of claim 1, wherein the position of each element in the presentation material is defined by one or more spatial location identifiers of that element as presented in the visualization of the presentation material on the user device during the presentation.

7. The method of claim 1, further comprising:
receiving a selection of a new element via the UI of the user device during the presentation;
using the knowledge model to create new supplemental information material related to a concept associated with the new element; and
adding the new element to the table, including linking, in the table, the new element with the new supplemental information material and a position of the new element in the presentation material.

8. The method of claim 7, wherein the knowledge model comprises a machine learning model (MLM) as well as preloaded documents in the specific knowledge area.

9. The method of claim 8, wherein the MLM is configured to adapt the supplemental information material in correspondence with a personal level of knowledge of a presentation participant associated with the user device.

10. The method of claim 8, wherein using the knowledge model to create the new supplemental information material comprises performing retrieval-augmented generation (RAG) using the MLM and the preloaded documents in the specific knowledge area.

11. The method of claim 7, further comprising storing the new element in a database of elements.

12. The method of claim 7, further comprising storing the new supplemental information material in a database of supplemental information.

13. A system for using machine learning to provide supplemental information material for a presentation, the system comprising:
at least one memory; and
at least one hardware processor coupled with the at least one memory and configured, individually or in combination, to:
receive presentation material associated with the presentation;
obtain, from a database, a table that links each element of one or more elements in the presentation with corresponding supplemental information material, the table further linking each element of the one or more elements with a position of that element in the presentation material, wherein the one or more elements are associated with one or more concepts related to the presentation and/or related to a specific knowledge area of a knowledge model used to generate the table; and
hold the presentation including using the presentation material and the table to provide a visualization of the presentation in conjunction with the corresponding supplemental information material on a user interface (UI) of a user device.

14. The system of claim 13, wherein the at least one hardware processor are further configured, individually or in combination, to hold the presentation by:
providing each element in the one or more elements as a selectable element that is selectable, via the UI of the user device, at the position of that element as presented in the visualization of the presentation material during the presentation; and
providing supplemental information material responsive to a selection of an element in the one or more elements via the UI of the user device during the presentation.

15. The system of claim 14, wherein the at least one hardware processor are further configured, individually or in combination, to:
provide, on the UI of the user device, a feedback form configured to receive feedback on the supplemental information material associated with the element;
receive, via the UI of the user device, further supplemental information material associated with the element; and
update the table to include the further supplemental information material in association with the element.

16. The system of claim 13, wherein the position of each element in the presentation material is defined by one or more spatial location identifiers of that element as presented in the visualization of the presentation material on the user device during the presentation.

17. The system of claim 13, wherein the at least one hardware processor are further configured, individually or in combination, to:
receive a selection of a new element via the UI of the user device during the presentation;
use the knowledge model to create new supplemental information material related to a concept associated with the new element;
add the new element to the table, including linking, in the table, the new element with the new supplemental information material and a position of the new element in the presentation material;
store the new element in a database of elements; and
store the new supplemental information material in a database of supplemental information.

18. The system of claim 13, wherein the knowledge model comprises a machine learning model (MLM) as well as preloaded documents in the specific knowledge area, wherein the at least one hardware processor are further configured, individually or in combination, to use the knowledge model to create the new supplemental information material by performing retrieval-augmented generation (RAG) using the MLM and the preloaded documents in the specific knowledge area.

19. The system of claim 18, wherein the MLM is configured to adapt the supplemental information material in correspondence with a personal level of knowledge of a presentation participant associated with the user device.

20. A non-transitory computer readable medium storing thereon computer executable instructions for using machine learning to provide supplemental information material for a presentation, including instructions for:
receiving presentation material associated with the presentation;
obtaining, from a database, a table that links each element of one or more elements in the presentation with corresponding supplemental information material, the table further linking each element of the one or more elements with a position of that element in the presentation material, wherein the one or more elements are associated with one or more concepts related to the presentation and/or related to a specific knowledge area of a knowledge model used to generate the table; and
holding the presentation including using the presentation material and the table to provide a visualization of the presentation in conjunction with the corresponding supplemental information material on a user interface (UI) of a user device.
